(19) United States
(12) Patent Application Publication
(10) Pub. No.: US 2009/0136637 A1
(43) Pub. Date: May 28, 2009

(54) Dehydration Method for Comminuted Food Products

(76) Inventors: Johannes Jozef M Janssen, Vlaardingen (NL); Stephan Georg Schumm, Vlaardingen (NL)

Correspondence Address: UNILEVER PATENT GROUP, 800 SYLVAN AVENUE, AG West S. Wing, ENGLEWOOD CLIFFS, NJ, 07632-3100, US

(21) Appl. No.: 12/086,096

(22) PCT Filed: Nov. 23, 2006
(86) PCT No.: PCT/EP2006/011385

§ 371 Date: Jun. 5, 2008

(30) Foreign Application Priority Data
Dec. 13, 2005 (EP) 05077961.0

(51) Int. Cl. A23P 1/00

(52) U.S. Cl. 426/312; 426/443; 426/319

(57) ABSTRACT

The present invention relates to a method of dehydrating a comminuted food product containing at least 30 wt. % of water, the method comprising: (i) comminuting a food product to form a slurry; (ii) contacting the obtained slurry with a pressurised gas to reduce the water content of said slurry by at least 50%, said pressurised gas having a pressure of at least 0.5xPc and a temperature of at least Tc-60° C., wherein Pc represents the critical pressure and Tc represents the critical temperature of the gas, whereby the pressurised gas is dried by removal of water contained therein and the dried pressurised gas thus obtained is recirculated to the slurry, wherein at least 80 wt. %, preferably at least 90 wt. % of the matter removed by the pressurised gas is water, and (iii) separating the pressurised gas from the dehydrated slurry.

### TECHNICAL FIELD OF THE INVENTION

The present invention relates to the field of food processing. More in particular, it relates to a method of dehydrating a comminuted food product such as a slurry, paste, or puree of crushed or ground plant or animal tissue, for example from fruits, vegetables, meat, shellfish or parts thereof. The dehydrated slurry obtained by the present method is capable of essentially instant, substantially uniform reconstitution upon the addition of water. Furthermore, the rehydrated slurry obtained after reconstitution exhibits an appearance and structure that is very similar to that of freshly mashed or ground plant or animal tissue.

### BACKGROUND OF THE INVENTION

It is well known in the art of food processing to dehydrate food materials, e.g. vegetables, to prevent decay and/or to reduce weight. Prior to consumption, such dehydrated materials are to be reconstituted with water so as to restore the appearance and eating qualities (flavour, texture etc.) of the original (fresh) food material.

Prior art endeavours in this field have resorted to rather severe dehydration treatments (e.g. hot air drying or spray drying at elevated temperatures) of the fresh product and/or to complex treatments of the product (e.g. freeze drying). The adverse impact of such processes on a number of characteristics of the fresh starting material is well known. For instance, spray drying will usually have a significant adverse effect on the flavour and the colour of the fresh starting material. Also, spray dried products generally do not rehydrate well. Freeze drying typically yields dehydrated products that are superior to hot air-dried or spray dried products in terms of flavour and colour. However, freeze-drying is not particularly economical, as it is a very slow process that consumes a lot of energy.

In short, the prior art has long recognized a need for a simple, effective method for preserving the fresh characteristics of mashed of ground plant or animal tissue. In addition, there is a general need for an economical dehydration method that does not adversely affect the desirable characteristics of the starting material as a result of e.g. heat induced or oxidative damage.

### SUMMARY OF THE INVENTION

Unexpectedly, the present inventors have found that it is possible to dehydrate slurries of comminuted food products, for example from mashed or ground plant or animal tissue by using a pressurised gas having a pressure of at least 0.5xPc and a temperature of at least Tc-60° C., wherein Pc represents the critical pressure and Tc represents the critical temperature of the gas, whilst retaining the fresh characteristics of the comminuted food product. More particularly, it was found that dehydration by means of a pressurised gas yields a dehydrated slurry that, after rehydration, exhibit qualities associated with freshness such as natural appearance, flavour, texture and colour. At the same time, the shelf life of the dehydrated product is appreciably extended as compared to the untreated product. Furthermore, the dehydrated slurry obtained by the present method rehydrates quickly and easily.

The present process can suitably be operated at relatively low temperatures, for example at ambient temperature. Thus, the detrimental effects of heat exposure can also be avoided. The inventors have also discovered that liquefied gas or supercritical gas may advantageously be used to dehydrate water-containing materials, particularly materials that contain components that are heat sensitive or that are prone to oxidation. Spray drying of such materials will cause significant quality loss whereas freeze drying often is not economical. When using pressurised gas to dehydrate these water containing materials, it is highly advantageous to recirculate the pressurised gas across the water containing material and water absorbent or water adsorbent so as to reduce the amount of pressurised gas needed during the process and to reduce the extraction of other food components (e.g. lipids, vitamins, flavours and other volatiles) due to saturation of the pressurised gas and selective removal of water only from the pressurised gas.

U.S. Pat. No. 6,026,565 discloses a process for the removal of sterols and/or lipid components from lipid containing food using super-critical fluids. It is noted in the US patent that after a particle reduction step, sub or supercritical fluid is used to remove water. Upon reaching a certain moisture content, fat and cholesterol will also be extracted. It is said that the meat should be dried to the range of 30-55% w/w. The examples show that significant water removal is accompanied by the extraction substantial amounts of fat.

### DETAILED DESCRIPTION OF THE INVENTION

Accordingly, the present invention relates to a method of dehydrating a comminuted food product containing at least 30 wt. % of water. In the first step, the food product is comminuted to form a slurry. The term “comminuted” as used herein means that the food product is treated by crushing or grinding, for example using food blenders, roll or hammer crushers or mills, disk grinders, pan mills, strainers, jet mills, impeller attritors, rotary grinders etc. to form a slurry or puree.

Typical examples of comminuted food products in the form of crushed or ground plant tissue that may advantageously be dehydrated by the present method include vegetables, fruit, herbs, spices as well as parts of these plant materials and any possible blends thereof. Preferably, the present method is employed to dehydrate vegetables (including legumes) and fruit. Preferred vegetables are carrots, tomatoes, broccoli, avocado, bell pepper, mushrooms, onions and garlic.

Examples of pieces of comminuted food products in the form of crushed or ground animal tissue that can suitably be dehydrated by the present method include shellfish, shrimps, beef, pork, chicken and fish meat and any possible blends thereof or blends of crushed and ground animal and plant tissue.

The comminuted food products can be used pure or pre-treated, for instance in cooked, blanched, roasted or grilled form.

Since the starting material (the food product) contains at least 30 wt. % water, the resulting comminuted slurry will also contain al least 30 wt. % water, but the over all water content may rise if additional materials are added to the slurry that have a higher water content.

The term “slurry” as used herein is meant to include pastes and purees and similar compositions. The slurries do not have to be completely homogeneous, but they may contain some particulate material.

Optionally, said slurry or puree can be pre-concentrated by centrifugation or filtration through a filter, sieve or membrane, in order to reduce the amount of water that has to be removed in the next steps of the process of the present invention.

If desired, the solid content of said slurry or puree can be increased by adding thickeners or water binders like starch, maltodextrin or proteins.

In the second step of the present process, the slurry of comminuted food material is contacted with a pressurised gas having a pressure of at least 0.5xPc and a temperature of at least Tc-60° C., wherein Pc represents the critical pressure and Tc represents the critical temperature of the gas. Water from the slurry is dissolved in said pressurised gas and thus removed from the slurry. The pressurised gas, wherein at least 80 wt. %, preferably at least 90 wt. % of the matter removed by the pressurised gas is water, is then dried by removal of water and the dry pressurised gas is recirculated to the slurry. The process is repeated until the water content of said slurry is reduced by at least 50%.

In the third step, the pressurised gas is separated from the dehydrated slurry or puree. The thus obtained dehydrated slurry or puree might optionally be milled or ground to decrease the particle size, more in particular, to form a powder.

The term “comminuted” as used herein in relation to plant or animal tissue means that said tissue is essentially destroyed, meaning that the majority of individual cells are no longer interconnected but where the individual cells are either destroyed or intact. The terminology “plant or animal tissue” encompasses parts of plant or animal tissue and mixtures thereof.

The term “gas” as used herein refers to a substance or element, or to a mixture of substances and/or elements that is/are gaseous at a pressure of 1 atmosphere and a temperature of 20° C. and that can be brought into a liquid or supercritical state by increasing pressure to at least 10 atmosphere, preferably to at least 20 atmosphere.

As compared to, for instance, freeze drying, the present method offers the advantage that the achievable dehydration rate is significantly higher. In the present method the ground or crushed plant or animal tissue is typically contacted with the liquefied or supercritical gas for at least 30 minutes so as to achieve a substantial reduction in moisture content. Depending on the moisture content of the starting material adequate dehydration can usually be achieved in 1-16 hours.

Typically, the solubility of water into pressurised gas is rather low. Thus, in order to avoid the use of large quantities of pressurised gas, the gas is recirculated across a means that is capable of removing the extracted water. Therefore, following the separation of the pressurised gas, said pressurised gas is dried by removal of water contained therein and the dried pressurised gas thus obtained is recirculated to the slurry or puree of the crushed or ground plant or animal tissue.

The water may be removed from the recirculated pressurised gas by any means known in the art. The extracted water may be recovered, for instance, by reducing the pressure and/or temperature of the gas so as to substantially decrease the solubility of water therein. Alternatively, in a preferred embodiment, the water is removed from the pressurised gas by contacting the gas with a water adsorbent or a water absorbent that is immiscible with said liquefied or supercritical gas. The water adsorbent or absorbent may be a liquid or solid, preferably particulate, material. Examples of suitable adsorbents and absorbents include activated silicates, including activated clays and aluminosilicates; inorganic salts (e.g. calcium chloride, sodium bicarbonate, sodium carbonate and calcium sulphate); superabsorbent polymers (especially polyacrylates; acrylate copolymers, chitosan salts and surfactant-treated polyolefins, e.g. surfactant-treated polypropylene); starch and modified starches. It is noted that starch may suitably be employed in the form of a natural organic material, e.g. corncob, paper, cork, peat or straw.

In an embodiment of the present invention the pressurised gas is percolated across or flowing across a horizontal thin layer, having a thickness in the order of millimeters, of a slurry or puree of plant or animal tissue or any blends thereof. In the present method the dehydrated material is suitably separated from the pressurised gas prior to adjusting the pressure and temperature to ambient conditions.

The present dehydration method suitably employs a pressure during contacting of the slurries or purees with the pressurised gas that is close to the critical pressure of the pressurised gas. Preferably, the pressure of the pressurised gas is at least 0.5xP_{c}, wherein P_{c} represents the critical pressure of the gas. Even more preferably the pressure of the pressurised gas is at least 0.7xP_{c} , most preferably at least 0.8xP_{c}. Usually the pressure of the pressurised gas will not exceed 10xP_{c}, preferably it will not exceed 5xP_{c}.

The temperature of the pressurised gas during the contacting with the crushed or ground plant or animal tissue advantageously is at least T_{c}-60° C., wherein T_{c} represents the critical temperature of the gas. Even more preferably, said temperature is at least T_{c}-40° C., most preferably at least T_{c}-30° C. In a preferred embodiment the temperature of the pressurised gas does not exceed T_{c}+60° C., more preferably it does not exceed T_{c}+40° C. In a particularly preferred embodiment the temperature of the pressurised gas during the contacting step does not exceed 70° C., more preferably it does not exceed 50° C. and most preferably it does not exceed 40° C.

The pressurised gas employed in the present method is advantageously selected from the group consisting of carbon dioxide, nitrous oxide, ethane, ethylene propane, cyclopropane, propylene, butane and mixtures thereof. In a particularly preferred embodiment, the liquefied or supercritical gas is carbon dioxide at a pressure of at least 40 bar, and a temperature between 0° and 200° C.

In order to achieve the extraction of substantial quantities of water from comminuted plant or animal tissue it is important to contact said purees and slurries with a pressurised gas with a low moisture content, e.g. a water content below 0.3 wt. %, more particularly a water content below 0.1 wt. %.

It is well known in the art to employ supercritical gasses, such as carbon dioxide, for the extraction of lipids, caffeine, flavour and colour components from plant materials. It is an objective of the present invention to provide a method in which the aforementioned components are retained in the plant or animal material. Accordingly, in a preferred embodiment at least 80 wt. % of the matter removed by the liquefied or supercritical gas in the present method is water. Even more preferably at least 90 wt. % and most preferably at least 95% of said matter is water.

As mentioned herein before, it is well known in the art to employ supercritical or near-critical gasses to selectively extract components other than water from plant materials. Usually, these methods use a pre-dried starting material. The present invention provides a method in which both the pre-drying and the extraction are conducted with the gas. Accordingly, this specific embodiment of the invention relates to a method as described herein before, wherein the method comprises reducing the water content of the material to less than 10%, followed by submitting the dehydrated material thus obtained to an extraction with the same gas, said gas being in a pressurised state, wherein the extraction removes at least 1% of lipophilic material by weight of dry matter contained in the said material. In a particularly preferred embodiment of the invention both the drying step and extraction step are conducted within the same equipment, preferably without removing the crushed or ground plant or animal tissue from the equipment until after the extraction has been completed.

Another aspect of the invention relates to the use of a pressurised gas for dehydrating comminuted plant or animal tissue containing at least 30 wt. % of water.

The invention will now be further illustrated by means of the following example.

### EXAMPLE 1

About 400 grams of peeled carrots were cooked for 15 minutes in water, drained and crushed for 5 minutes in a standard food blender to obtain a slurry. The slurry was then positioned as a thin layer on a horizontal tray in a pressure vessel that can be heated or cooled by means of a jacket filled with oil. A second vessel was filled with sufficient amount of dry zeolite 3A to act as a moisture absorber. Dry, supercitical CO₂ (40° C. and 100 bar pressure) was then circulated over the two pressure vessels by means of a circulation pump to carry the moisture from the sample to the zeolite. The extraction was continued for 16 h. Subsequently, the CO₂ was removed from the vessel via a valve mounted one side of the vessel. After the pressure release, the vessel was opened and the tray with the dehydrated slurry was removed. After scraping off the dried material from the tray an orange powder was obtained. No appreciable off-flavour was detected either by tasting or smelling.

1. A method of dehydrating a comminuted food product containing at least 30 wt. % of water, the method comprising:
(i) comminuting a food product to form a slurry;
(ii) contacting the obtained slurry with a pressurised gas to reduce the water content of said slurry by at least 50%, said pressurised gas having a pressure of at least 0.5xPc and a temperature of at least Tc-60° C., wherein Pc represents the critical pressure and Tc represents the critical temperature of the gas, whereby the pressurised gas is dried by removal of water contained therein and the dried pressurised gas thus obtained is recirculated to the slurry, wherein at least 80 wt. %, preferably at least 90 wt. % of the matter removed by the pressurised gas is water, and
(iii) separating the pressurised gas from the dehydrated slurry.

2. Method according to claim 1, wherein the obtained dehydrated slurry is further comminuted, preferably to form a powder.

3. Method according to claim 1, wherein the slurry is a slurry of mashed or ground plant or animal tissue.

4. Method according to claim 1, wherein the slurry of comminuted plant tissue is obtained from vegetables, fruit, herbs, spices, parts of these plant materials or blends thereof.

5. Method according to claim 1, wherein the slurry of comminuted plant or animal tissue is contacted with the pressurised gas for at least 30 minutes, preferably for 1-16 hours.

6. Method according to claim 1, wherein the water is removed from the pressurised gas by contacting the gas with a water absorbent or a water absorbent that is immiscible with said pressurised gas.

7. Method according to claim 1, wherein the pressurised gas is a liquefied or supercritical gas.

8. Method according to claim 1, wherein the gas is selected from the group consisting of carbon dioxide, nitrous oxide, ethane, ethylene propane, cyclopropane, propylene, butane and mixtures thereof.

9. Method according to claim 1, wherein the pressurised gas is carbon dioxide at a pressure of at least 40 bar, and a temperature between 0° and 20020 C.

10. Method according to claim 1, wherein the water content of pressurised gas that is brought into contact with the slurry is below 0.1 wt. %.

11. Method according to claim 1, wherein the dehydrated slurry contains less than 10 wt. % water.

12. Method according to claim 1, comprising reducing the water content of the material to less than 10%, followed by submitting the dehydrated material thus obtained to an extraction with the same gas, said gas being in a pressurised state, wherein the extraction removes at least 1% of lipophilic material by weight of dry matter contained in the said material.
